(19) United States
(12) Patent Application Publication
(10) Pub. No.: US 2014/0303768 A1
(43) Pub. Date: Oct. 9, 2014

(54) Method for Operating a Production Plant

(71) Applicants: Willi Klumpp, Ostfildern (DE); Matthias Reichenbach, Stuttgart (DE); Matthias Schreiber, Bietigheim-Bissingen (DE); Volker Zipter, Stuttgart (DE); Michael Zuern, Sindelfingen (DE)

(72) Inventors: Willi Klumpp, Ostfildern (DE); Matthias Reichenbach, Stuttgart (DE); Matthias Schreiber, Bietigheim-Bissingen (DE); Volker Zipter, Stuttgart (DE); Michael Zuern, Sindelfingen (DE)

(73) Assignee: Daimler AG, Stuttgart (DE)

(21) Appl. No.: 14/362,801

(22) PCT Filed: Dec. 9, 2011
(86) PCT No.: PCT/EP2011/006204

§ 371 Date: Jun. 4, 2014

(51) Int. Cl. G05B 19/418

(52) U.S. Cl. CPC G05B 19/4189
USPC 700/113

(57) ABSTRACT

A method for operating a production plant having an unmanned transport system involves transporting a first parts carrier having a plurality of parts from a warehouse to a picking station by at least one industrial truck. At least one part, which is predetermined according to a parts list, is extracted from the parts carrier using a worker and deposition of the part on a further parts carrier. The further parts carrier is transported to a work station by a further industrial truck.

### BACKGROUND AND SUMMARY OF THE INVENTION

Exemplary embodiments of the invention relate to a method to operate a production plant having an unmanned transport system.

Individual work stations of production plants must be supplied with components, work materials and the like, which are usually held in a separate warehouse. Typically, for this purpose, component sets are assembled at so called picking stations, which are specifically for individual work stations of the product plant. For this purpose, an order picker collects the individual parts belonging to the component set from the warehouse and deposits them on a partial carrier, which is subsequently transported to the respective work station. Such systems are both complex and time-consuming, as the throughput of individual picking stations is heavily limited by the respective necessary path to the warehouse. The flexibility of the known method is also heavily limited, such that the supply of work stations of the production plant with changing work tasks is only able to be implemented with difficulty, as a different component set is needed for each new work task.

German patent document DE 10 2006 057 758 A1 discloses an alternative to the described system. The method described therein relates to a completely automated high rack warehouse, in which parts are extracted from the high rack by means of a separation robot and are loaded onto an autarchic transport vehicle. The transport vehicle is subsequently moved to a pallet station having a pallet robot, where the extracted parts are arranged in a desired arrangement on a transport pallet. Such warehousing systems have a very high throughput and can be flexibly re-programmed. The complete automation of a warehouse management system according to the type described is, however, complex and leads to high investment costs.

Exemplary embodiments of the present invention are directed to a method for operating a production plant that enables a flexible and cost-efficient picking of parts for a production plant.

Such a method serves to operate a production plant having an unmanned transport system comprising a plurality of industrial trucks designed to receive control instructions from a control device. At least one first part carrier having a plurality of parts is transported from a warehouse to a picking station by means of a first industrial truck. At the picking station, at least one part predetermined according to a parts list is extracted from the parts carrier by a worker and is deposited on a further parts carrier. The further parts carrier is finally transported to a work station by means of a further industrial truck.

Compared to known methods to pick materials, the time-consuming path of the worker into the warehouse can be omitted. Instead, a pre-selection of parts is delivered directly to the picking station, where the necessary parts can thus be re-sorted on the further parts carrier according to the parts list. This enables a particularly quick picking At the same time, a flexible adaptation of the picking procedure is possible, as in the case of changes of the production requirements in the production plant, the equipping of the first partial carrier can be changed without problem in the warehouse, such that the necessary selection of parts is always present at the picking station.

Compared to fully-automated warehousing systems, the method according to the invention is substantially more cost-efficient, as substantially lower investments are necessary due to the low degree of automation. Overall, a particularly flexible and cost-efficient picking method that is, at the same time, simple to carry out, is thus created.

In a preferred embodiment, the parts list is assembled according to a production volume of the work station. The further parts carrier thus receives precisely the parts the work station needs to fulfil a predetermined number of work tasks. Changes to the work task of the work station can be directly accompanied in the picking station by a change of the equipping of the further parts carrier, such that a particularly flexible method is created.

In a preferred embodiment, the parts list is stored by the picking station in a storage device of the further industrial truck and/or of the further parts carrier. This expediently occurs using a wireless data transfer. The industrial truck or the parts carrier can later communicate both with the work station and with the control device on the basis of the stored parts list. Communication with the control device enables the industrial truck to be guided to its target destination according to the current requirements of the product plant. Once arrived at the target destination, the parts list can be transferred to a robot of the work station, such that this recognizes the equipment layout of the parts carrier and can extract the parts in the necessary order.

The work station itself can transfer its parts requirement to the control device. This can determine the parts list and also expediently send it to the picking station wirelessly. Thus, changes in the parts requirement of the work station are transferred directly to a changed picking.

In a further preferred embodiment of the method, a rack is used as a first parts carrier. This can be installed in a fixed manner on the unmanned industrial truck or can even be fixed temporarily to this. Such a rack enables a plurality of parts sorted by the workers of the picking station to be provided.

The unmanned industrial trucks of the production plant can also fulfil a further goal beyond merely the simple task of transportation. It is, for example, advantageous to dock the further parts carrier in a defined place at the work station using the further industrial truck. This simplifies the gripping of the parts provided on the further parts carrier by the robots of the work station, as the geometrical position thereof relative to the base of the robot is known exactly using the fixed position of the parts carriers as well as, if necessary, using the transferred data.

This is likewise able to be used expediently for the transport of components to be processed. In a preferred embodiment of the invention, at least one such component to be processed is transported by means of a third industrial truck to the work station and is likewise docked in a defined position with respect to this. This likewise brings the component into a defined location with relation to the base of the robot, such that the further processing thereof is simplified. Here, the third industrial truck or the third parts carrier can also additionally transfer data to the work station. This is expediently information about the component to be processed, which can be deposited in a storage device of the third industrial truck and/or of the third parts carrier. In order to create a higher parts throughput, it is expedient to transport a plurality of components to be processed to the third parts carrier.

### BRIEF DESCRIPTION OF THE DRAWING FIGURES

The invention and its embodiments are described in more detail below by means of the drawings. Herein it is shown:

FIG. 1 the schematic sequence of an exemplary embodiment of a method according to the invention;

FIG. 2 a schematic depiction of a work station of a production plan for use with an exemplary embodiment of a method according to the invention; and

FIG. 3 a schematic depiction of the procedures in work piece and material transport to the work station according to FIG. 2.

### DETAILED DESCRIPTION

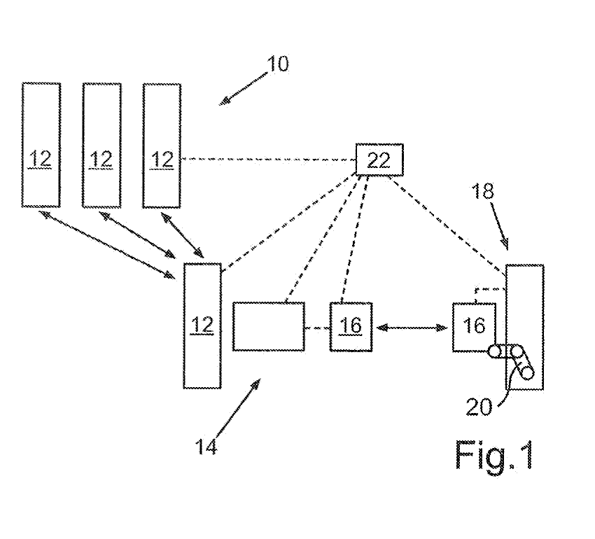

In order to store components, required materials and similar for a production plant, a warehouse 10 is provided which comprises several racks 12. The racks 12 are assembled on the autonomous industrial trucks, which are not depicted in FIG. 1, and can be moved by a control device 22 to the desired location. The racks 12 are stored in a completely equipped manner in the warehouse 10 and are brought to a picking station 14 by the control device 22 in reaction to requirements.

At the picking station 14, a worker receives a parts list which corresponds to a current production requirement. According to this parts list, the worker extracts components and materials from the rack 12 and transfers them to a further parts carrier 16, which is likewise assembled on an autonomous industrial truck. Alternatively, this work can also be carried out by a robot. In the case of a complete equipping of the parts carrier 16, the industrial truck is moved under instruction of the control device to the work station 18 of the production plant, where the delivered components and materials are processed by a robot 20. The work station 18 registers its parts requirement with the control device 22 via a wireless communication system, which generates a parts list for the picking station 14 from this and transfers this to the picking station 14. The control device 22 furthermore transfers the current requirements of the picking station 14 to the warehouse 10 and controls the autonomous industrial truck, which transports the racks 12 and the parts carriers 16. Changes to the production task of the work stations 18 can therefore be transferred flexibly in the shortest amount of time to the warehousing and picking system.

FIG. 2 shows the work station 18 in detail. This comprises a table 24 on which two lightweight robots 26 are mounted as well as a press 28 that is installed in a fixed manner. The component carriers 32 having components 30 to be processed are delivered to the front side of the table 24, where the components 30 to be processed are processed by the robots 26. A particularly quick processing of the components 30 and a high component throughput through the work station 18 is possible due to the storage of several components 30 to be processed on each component carrier 32.

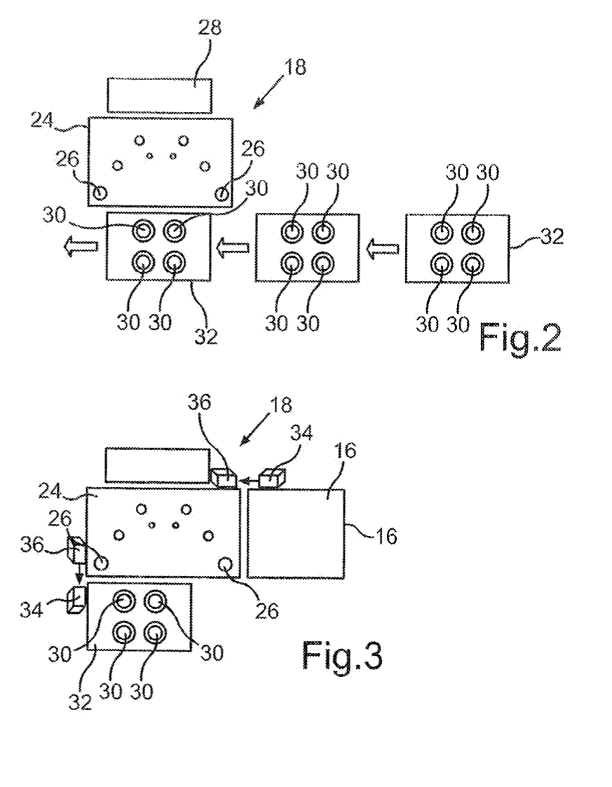

At the same time, as is shown in FIG. 3, a further component carrier 16 is delivered to the work station 18 having individual parts and required materials, said component carrier 16 likewise being docked at the table 24. The robots 26 extract the required materials from the component carrier 16 in order to process the components 30.

Respective storage devices 34 are inserted into the component carriers 16 and 32, which can communicate wirelessly with a control device 36 of the work station 18. Both the parts carrier 16 and the parts carrier 32 can thus transfer its equipment and if necessary its tasks to be carried out to the work station 18. This includes positional data for the components and materials loaded onto the parts carrier 16, 32, such that these can be gripped by the robots 26 without problem. The processing steps to be carried out can be deposited in the storage devices 34.

Overall, a particularly flexible picking and processing system is thus created, which is suited in particular for the production of goods with frequently changing processing requirements. An example of this is the use in small batch production; the system can however obviously also be used in the usual large batch production.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A method to operate a production plant having an unmanned transport system, which comprises a plurality of industrial trucks configured to receive control instructions from a control device, the method comprising:
transporting, by a first one of the plurality of industrial trucks, a first parts carrier having a plurality of parts from a warehouse to a picking station;
extracting, by a worker or robot, at least one part, which is predetermined according to a parts list, from the parts carrier;
depositing the extracted part on a further parts carrier; and
transporting, by a second one of the plurality of industrial trucks, the further parts carrier to a work station.

11. The method of claim 10, further comprising:
assembling the parts list is assembled according to a production volume of the work station.

12. The method of claim 10, further comprising:
storing, by the picking station in a storage device of the second one of the plurality of industrial trucks or the further parts carrier, the parts list.

13. The method of claim 12, further comprising:
transferring the parts list at the work station from the storage device to a robot of the work station.

14. The method of claim 10, wherein the parts list is determined by the control device according to a requirement of the work station and is transferred to the picking station.

15. The method of claim 10, wherein the first parts carrier is a rack.

16. The method of claim 10, wherein the further parts carrier is docked in a defined position at the work station by the second one of the plurality of industrial trucks.

17. The method of claim 10, further comprising:
transporting at least one component to be processed on a third parts carrier by a third one of the industrial trucks to the work station and docking the third parts carrier in a defined position at the work station.

18. The method of claim 17, wherein information about the at least one component to be processed is transferred from a storage device of the one of the third industrial trucks or of the third parts carrier to a robot of the work station.
